(19) United States
(12) Patent Application Publication
(10) Pub. No.: US 2026/0058454 A1
(43) Pub. Date: Feb. 26, 2026

(54) Cable Retaining Clip

(71) Applicant: HIRSCHMANN AUTOMOTIVE GMBH, Rankweil/Brederis (AT)

(72) Inventors: Simon NESSLER, Röthis (AT); Ümit BAS, Sulz (AT)

(21) Appl. No.: 19/103,318

(22) PCT Filed: Aug. 10, 2023
(86) PCT No.: PCT/EP2023/072182

§ 371 Date: Feb. 12, 2025

(30) Foreign Application Priority Data
Aug. 25, 2022 (DE) 10 2022 121 585.7

(51) Int. Cl. H02G 3/38; H02G 3/04

(52) U.S. Cl. CPC H02G 3/38; H02G 3/0437

(57) ABSTRACT

A system includes a device at an installation location, a cable, and at least one associated fastening clip having at least one locking tab or protrusion. The device at the installation location has at least one recess into which the at least one locking tab or protrusion is inserted, thereby locking or fixing the at least one locking tab or protrusion in position.

The invention relates to an improvement in the fixing of a cable or a cable harness (such as electrical cables for low-voltage (LV) or high-voltage (HV) applications, data cables or the like) at its intended installation location, for example a cable shaft, a cable duct or the like.

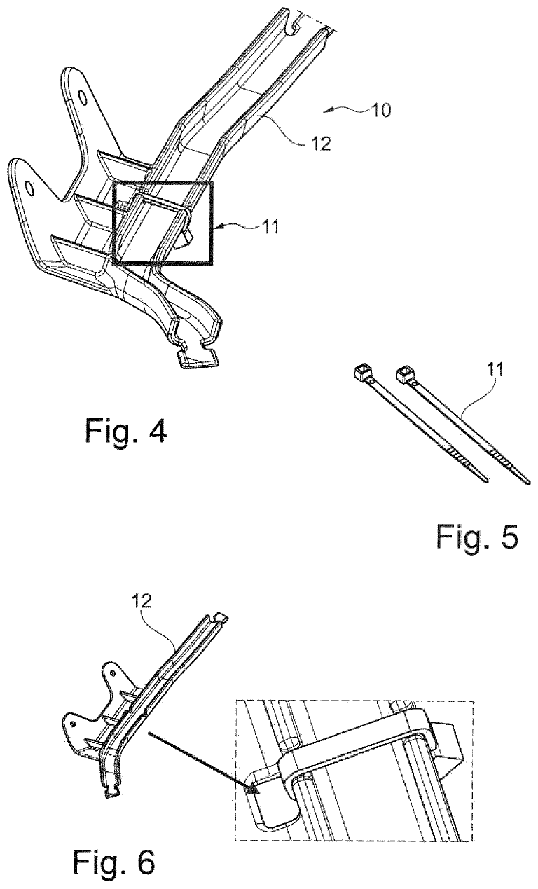

The fastening according to the prior art according to the illustrations in FIG. 4 to 6, which shows an arrangement 10, is carried out by means of standard cable ties 11 available on the market, which are associated with a rather slow assembly process. Sharp edges after cutting off the excess material (protruding tail of the cable tie) are also a problem for ergonomics. By cutting off the excess material, unnecessary and therefore costly waste is produced.

The installation location, for example an elongated shaft 12 into which the cable (not shown) or the like is inserted, with cable ties 11 for fixing the position of the cable harness, has the disadvantage that the effort required to thread the cable tie 11 into the correct position is very time consuming. The positioning of the cable tie head is also made more difficult because it is not easily accessible.

The object of the invention is therefore that of improving the design and assembly described above.

For this purpose, according to the invention, an arrangement is provided, consisting of a device at the installation location, a cable and at least one associated fastening clip having at least one locking tab, the device at the installation location having at least one recess into which the at least one locking tab is inserted and thereby fixed in its position.

According to the invention, a cable fixation for HV (high voltage) and LV (low voltage) cable sets in shafts or holders is provided by means of a plug-in plastics element, which is: faster (low overall cycle time), safer (risk of injury), more cost effective (in-house production possible), sustainable (sprue can be recycled), universally designed, and can be used across customers and applications.

Overall, this thus results in the following advantages:
Cycle time
   Quick assembly
   No cycle time loss due to threading cable ties
   Enormous overall cycle time savings for high volumes
   Ergonomics
   Easy handling and safe installation
   No risk of injury from sharp edges (cut off end of cable tie)
   Fewer work steps
Cost
   In-house production, consequently no purchased parts
   Low costs of injection molding tools due to simple geometry
   No waste, resulting in: sprue can be internally reprocessed into regranulate
   High quantities of individual clips, as they can be used by different customers
Environment
   No waste in contrast to cable ties; cut-off cable tie residue is avoided as cable tie waste cannot be recycled internally
   Fewer transport routes because parts are manufactured internally
   Depending on customer requirements, parts can be manufactured with a very high proportion of regranulate, which makes them recyclable.

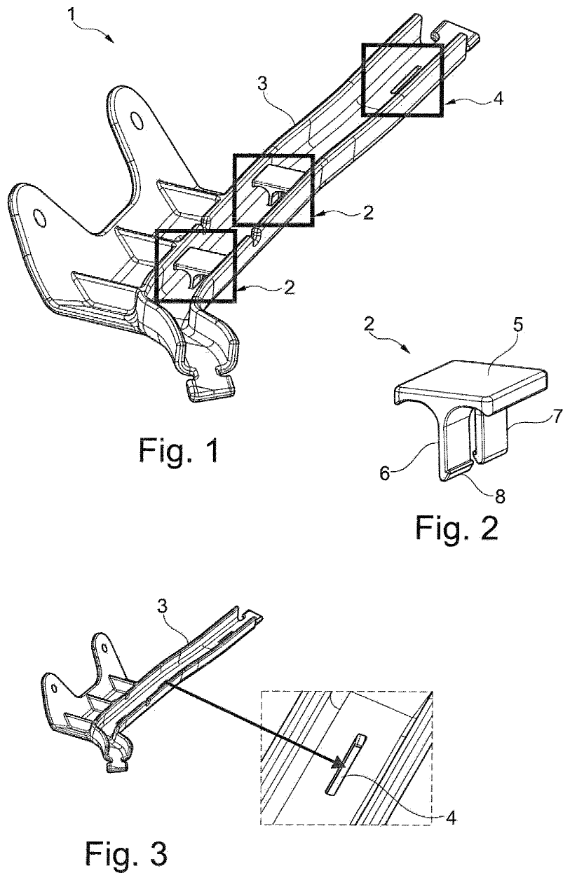

The arrangement according to the invention is shown in FIG. 1 to 4 and explained below.

For this purpose, as shown in FIG. 1, the arrangement 1, consisting of a device at the installation location (for example a cable duct 3, a cable channel or the like), a cable (not shown, but in practice present by inserting it, for example, into the cable duct 3) and at least one associated fastening clip 2 (also called a cable fixing clip), is designed as follows:

The fastening clip 2 according to the invention has, for example, two locking tabs 6, 7 of the same or different length protruding from a flat base 5. The cable duct 4 or the like has a recess 4 (opening) into which one of the locking tabs 6, 7 is inserted and thereby fixed in its position. This preferably resilient locking tab 6, 7 can thus be easily, quickly and guidedly inserted into the recess 4 provided for it in the cable duct 3 (generally in the device at the installation site) and fixed in its position. The fastening clip 2 is secured against pulling out by a barb geometry, in particular a latching hook 8 at the end of the locking tab 6, 7, which is inserted into the recess 4. Alternatively or in addition, the cross-section of one locking tab 6, 7 can be designed to be slightly larger than the cross-section of the recess 4, so that the locking tab 6, 7 is pressed into the recess 4 (press fit).

Looking at FIG. 2, the fastening clip 2 has two locking tabs 6, 7. These two locking tabs extend from the flat base 5. The two locking tabs 6, 7 with different lengths are shown. But they can also have the same length. One of the locking tabs 6, 7 or, as shown, both, can have the barb geometry (here at the respective end of the locking hooks 8). The cable (not shown) is inserted between the underside of the flat base 5 and the top of the cable duct 4 and secured by means of the fastening clip 2. If, as shown in FIG. 2, two locking tabs 6, 7 are present that are spaced apart from one another, the cable can be inserted between these two locking tabs 6, 7. Alternatively or in addition, at least one further cable can be inserted into the cable duct 3 next to the one locking tab 6 and/or next to the other locking tab 7 and fixed in its position by means of the fastening clip 2. This can optionally be supported by the at least one side wall of the cable duct 3 if the at least one cable not only comes into contact with the locking tab 6, 7, but also with the side wall. It is also conceivable to have an embodiment of the arrangement according to the invention in which the cable only comes into contact with at least one of the locking tabs 6, 7 or also only with at least one side wall or only comes into contact between the flat base 5 and the bottom of the cable duct 3 and is exposed at the sides. In the arrangement according to FIG. 2, only one cable (when looking at FIG. 2, to the left of the locking tab 6 or to the right of the locking tab 7 or between the two locking tabs 6, 7) or correspondingly two cables or three cables can be inserted and fixed in the cable duct 3.

The new fastening simplifies the geometry of the cable duct 3 (generally the device at the installation site). The reason for this is that no geometries need to be provided for the positioning of cable ties. The recesses for the clips also save material.

The intended fastening location does not necessarily have to be a shaft (for example with a U-shaped cross-section), but can also be flat (such as a wall or a body component of a vehicle). A plurality of fastening clips 2 can also be used along the cable to fix it, as shown in FIG. 1.

### LIST OF REFERENCE SIGNS

1. arrangement (“new”, according to the invention)
2. fastening clip
3. cable duct
4. recess (also called opening)
5. flat base
6. locking tab
7. locking tab
8. locking hook
10. arrangement (“old”, according to the prior art art)
11. cable ties
12. cable duct

1.-8. (canceled)

9. A system comprising a device at an installation location, a cable, and at least one associated fastening clip having at least one locking tab, wherein the device at the installation location has at least one recess into which the at least one locking tab is insertable, thereby locking or fixing the at least one locking tab in position.

10. The system of claim 9, wherein the fastening clip includes two locking tabs protruding from a flat base.

11. The system of claim 10, wherein the two locking tabs have the same length.

12. The system of claim 10, wherein the two locking tabs have different lengths.

13. The system of claim 9, wherein the at least one locking tab has a barb geometry which is insertable into the recess such that the fastening clip is secured against pulling out.

14. The system of claim 13, wherein the barb geometry is a locking hook at the end of the locking tab, which is insertable into the recess.

15. The system of claim 9, wherein the device at the installation location is a cable duct or a cable channel.

16. The system of claim 9, wherein:
the fastening clip includes two locking tabs having different lengths;
the device at the installation location is a cable duct or a cable channel; and
the cable duct or the cable channel has at least one recess into which the longer locking tab of the two locking tabs is insertable and thereby fixed in its position.
